(19) United States
(12) Patent Application Publication
(10) Pub. No.: US 2022/0080774 A1
(43) Pub. Date: Mar. 17, 2022

(54) IMPROVED SPOKE TO COMPLIANT-BAND ATTACHMENT

(71) Applicant: Compagnie Generale des Etablissements Michelin, Clermont-Ferrand (FR)

(72) Inventors: Antonio DELFINO, Givisiez (CH); Gael ROTY, Ladoux (FR)

(21) Appl. No.: 17/419,900

(22) PCT Filed: Dec. 31, 2019
(86) PCT No.: PCT/IB2019/061463

§ 371 Date: Jun. 30, 2021

Related U.S. Application Data
(60) Provisional application No. 62/787,089, filed on Dec. 31, 2018.

(51) Int. Cl. B60C 7/14; B60C 7/18; B60C 7/24

(52) U.S. Cl. CPC B60C 7/143; B60C 7/146; B60B 1/043; B60C 7/24; B60C 7/18

(57) ABSTRACT

A non-pneumatic tire having a compliant tread band (58) and a plurality of spokes (100) each having a web-like body (102), and each body (102) containing a number of elongate reinforcement elements (124) oriented in the radial direction of the tire. The radially-outer portion of each spoke extends proximate to the adjacent radially-outer portion of the adjacent spoke.

### FIELD OF THE INVENTION

The present invention relates to non-pneumatic tire.

### BACKGROUND OF THE INVENTION

Non-pneumatic wheel constructions and their benefits are described in e.g., U.S. Pat. Nos. 6,769,465; 6,994,134; 7,013,939; and 7,201,194. Some non-pneumatic wheel constructions propose incorporating a shear band, embodiments of which are described in e.g., U.S. Pat. Nos. 6,769,465 and 7,201,194. Such non-pneumatic wheels provide advantages in wheel performance without relying upon a gas inflation pressure for support of the loads applied to the wheel.

In one example of a non-pneumatic wheel, a compliant band with a ground contacting portion can be connected with a plurality of tension-transmitting, web-like elements (i.e. spokes) extending radially from a center element or hub. For certain constructions, such non-pneumatic wheel may be formed by open cast molding in which a material such as e.g., polyurethane is poured into a mold that forms all or part of the non-pneumatic wheel. One or more inextensible reinforcement structures such as cords may be molded in place in the compliant band.

Typically, in such prior constructions, the spokes and the hub are molded as an integral, single-piece construction. Alternatively, the spokes may be integrally joined by a band that is then joined with a hub or wheel center. In either construction, the spokes are not readily removable from either the radially-outer end attached with the compliant band or the radially inner end attached to the hub or wheel center, nor does the integral, single piece construction lend itself to use of reinforced rubber for construction of the spoke components.

Non-pneumatic wheels constructed using rubber allow the use of sheets of rubber containing reinforcement material, such as cords embedded in the rubber spokes. Construction of the spokes individually allows for rubber spoke precursor material to be pressed, shaped, cut and assembled with the reinforcements positioned in a desired orientation and location. Once the precursor material is placed into a mold, application of pressure and heat is used to cure the rubber to obtain the final material properties suitable for use in a tire and lock in the desired shape of the spoke. The individual spokes then can be arranged and a material is applied to the radially outer end surface of the spokes to bond the spokes to a compliant shear band as described in PCT patent application publication WO 2017/117598. As pressure is applied, pressing the spokes into the compliant load supporting band, the bonding material migrates and an uneven thickness of the bonding layer may result. When this occurs, the uneven thickness is thought to cause increased localized strains that create cracks and hasten separation of the spoke from the compliant shear band.

Accordingly a non-pneumatic tire having spokes configured so as to allow for the bonding of individual spokes to the compliant load supporting band with a uniform thickness of the bonding layer would be desirable. A tire construction that simplifies the method of manufacturing would also be desirable. A method of manufacturing such a tire would also be beneficial.

### SUMMARY OF THE INVENTION

The present invention provides an exemplary non-pneumatic tire having spokes bonded to a shear band wherein the radially outer end of each spoke extend to the radially outer end of each adjacent spoke. The spoke can be manufactured with a reinforcement structure having reinforcement elements and one or more layers of material. The spoke can also be provided in various shapes and configurations. The spoke includes radially inner anchors that allow the spoke to be more readily incorporated into, or removed from a hub. More particularly, the anchors also allow the spoke to be joined as one-piece with a hub or releasably connected to a hub to form a wheel. Additional objects and advantages of the invention will be set forth in part in the following description, or may be apparent from the description, or may be learned through practice of the invention.

In one exemplary embodiment of the present invention, a tire comprising a compliant load supporting band and a plurality of spokes is provided. The tire may be attached to a hub to form a non-pneumatic wheel. The tire defines radial, axial, and circumferential directions. The spoke includes a web-like body extending along the radial direction between a radially-outer end and a radially inner end and extending along an axial direction between opposing edges of the web-like body.

Each spoke includes a radially outer anchor positioned at the radially outer end. The radially outer anchor includes an outer pair of arms extending in an opposing manner along the circumferential direction away from the web-like body. A radially inner anchor may be positioned at the radially inner end and may include an inner pair of arms extending in an opposing manner along the circumferential direction away from the web-like body. One of the pair of arms of the radially outer anchor of each spoke extends proximate a radially outer anchor of an adjacent spoke.

In at least one embodiment the radially outer end of each spoke contact the radially outer end of each adjacent spoke.

In at least one alternative embodiment, the radially outer end of each spoke possesses a pair of arms, the first arm extending in a first circumferential direction and a second arm extending in a second circumferential direction opposite the first circumferential direction. Each arm possesses an edge farthest from the web-like body of the spoke and a thickness measured in the radial direction. Wherein in this alternative embodiment, the thickness of each arm is greater at a location adjacent to the web-like body than at a location at the edge of each arm. Wherein the first arm of the outer anchor of each spoke extends proximate to the second arm of the outer anchor of the adjacent spoke such that the distance between the first arm and the second arm of the adjacent spoke is less than the lesser of the thickness at the edge of the first arm or the thickness at the edge of the second arm.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an exemplary non-pneumatic wheel incorporating an exemplary embodiment of a non-pneumatic tire of the present invention.

FIG. 2 provides a side view of the exemplary non-pneumatic wheel of FIG. 1.

FIG. 3 illustrates a partial side view of a prior art spoke attachment to the outer compliant band.

FIG. 4 illustrates a partial side view of an exemplary embodiment of the spoke attachment to the outer band.

FIG. 5 is a partial side view of an exemplary embodiment with the outer compliant band removed showing the positioning of the spoke's first radially-outer anchor leg extending to an adjacent spoke's second radially-outer anchor leg.

FIG. 6 is a radially inner partial perspective view of an embodiment with the outer compliant band removed.

FIG. 7 is a side view of an alternative exemplary embodiment showing “single” spokes.

FIG. 8 provides a sectional view of the exemplary embodiment taken along line 8-8 of FIG. 7.

FIG. 9 provides a side view of a single spoke of the exemplary embodiment of FIG. 7 showing reinforcement within the spoke web.

FIG. 10 provides an exemplary method of constructing an embodiment of a non-pneumatic tire.

FIG. 11 is an alternative exemplary method of assembling an embodiment of a non-pneumatic tire.

### DETAILED DESCRIPTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

As used herein, the following definitions apply.

Axial direction A refers to a direction parallel to an axis about which a referenced exemplary wheel rotates during use.

Radial direction R refers to a direction perpendicular to axial direction A with radially-outer or radially outward referring to a general direction away from axial direction A, and radially-inner or radially inward referring to a general direction towards axial direction A. The arrow associated with R points along a radial direction and from radially-inward to radially-outward when used in reference to the position and orientation of spoke 100 or its components within non-pneumatic wheel 50.

Circumferential direction C refers to a direction defined by defined by the circumference of the wheel or the direction of its rotation about an axis.

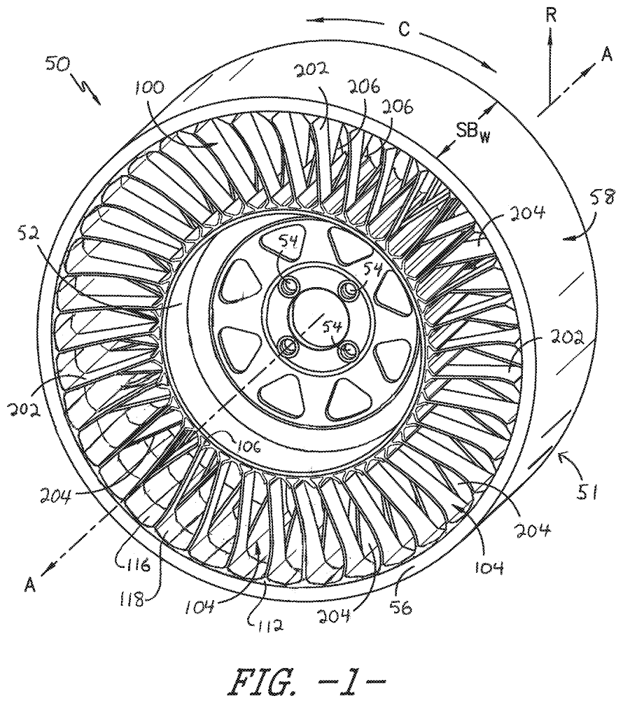

FIG. 1 provides a perspective side view of an embodiment of the invention attached to a hub 52 forming a non-pneumatic wheel 50. Here the tire 51 embodiment comprises a plurality of spoke segments 100 attached at their radially outer end 104 to the radially inner surface of a compliant load supporting band 56. The radially outer end 104 of each spoke segment 100 is proximate to the radially outer end 104 of the adjacent spoke. This is possible because each spoke segment 100 possesses a radially outer anchor 112 that possesses a first radially outer anchor arm 116 and a second radially outer anchor arm 118 and the first radially outer anchor arm 116 of each spoke extends to the second radially outer anchor arm 118 of the adjacent spoke. The plurality of tension-transmitting web elements or spokes 100 extend along the radial direction R between hub 52 and compliant load supporting band 56. Spokes 100 are adjacent to one another and spaced apart about circumferential direction C of wheel 50.

In FIG. 1, the embodiment shown of the non-pneumatic tire 51 is attached to a hub 52 at the radially inner end 106 of each spoke. Each spoke is generally oriented in the radial direction but each spoke does not necessarily have to lay parallel to the radial direction. Each spoke may be oriented at an angle to the radial direction such that the spoke 100 extends from the radially-outer compliant band 56 to the radially-inner hub 52.

Each spoke 100 of the embodiment extends across the axial width of the tire but is split into three spoke segments 202, 204, 206. The center segment 204 is generally aligned with the radial direction but offset in a first circumferential direction while the first outer spoke segment 202 and the second outer spoke segment 206 are generally aligned with the radial direction but is offset in a second circumferential direction opposite to the first circumferential direction. It should be understood that a tire in accordance with the invention may have one spoke segment per spoke, two spoke segments per spoke, three spoke segments per spoke or more. The hub 52 shown possesses a plurality of apertures 54 for fastening the hub to a vehicle. It should be understood that the present invention is not limited to the particular shape, size, or appearance of the wheels shown in the figures. As will be understood using the teachings disclosed herein, wheels of other shapes, sizes, and appearances may be used as well.

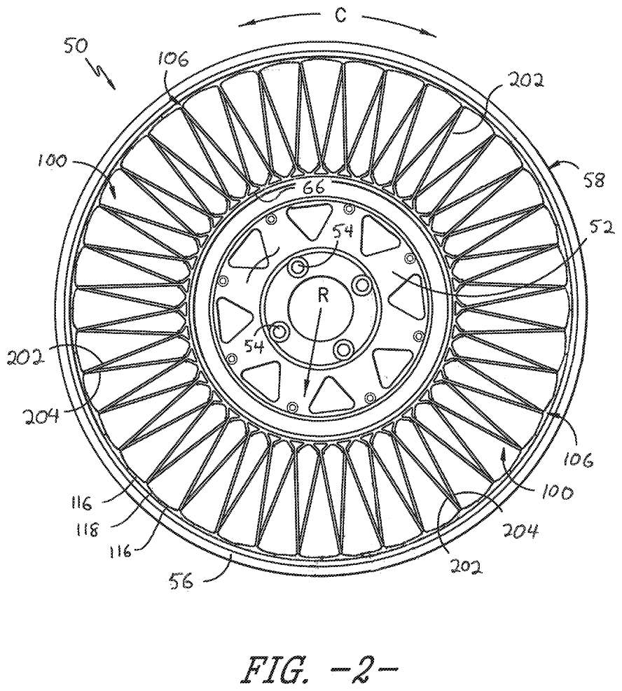

As shown in FIG. 2, the non-pneumatic wheel 50 includes a wheel hub 52 provided with a series of apertures 54 through which threaded lugs or other fasteners may be inserted in order to mount wheel 50 onto a vehicle. Other mounting configurations may be used as well. Non-pneumatic wheel 50 also includes a compliant, load supporting band 56 positioned radially outward of a hub 52 and positioned concentrically with hub 52. A tread 58 may be formed on, or provided as part of, load supporting band 56. For example, tread band 58 may be adhered to load supporting band 56, embedded therein, or formed integrally as shown in FIG. 2. Other constructions may be used as well. The tread 58 may have a textured surface and include grooves, sipes or other surface features, or may be smooth as shown in the embodiment in FIG. 1.

In one exemplary embodiment, as wheel 50 rotates, spokes 100 are in tension as they reach the top of the wheel at a position away from the contact patch while spokes 100 near the contact patch may experience minimal tension and may even slightly buckle or bend as they enter the contact patch as the wheel rotates under load.

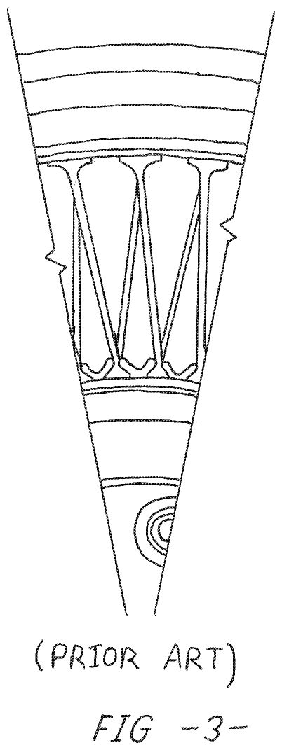

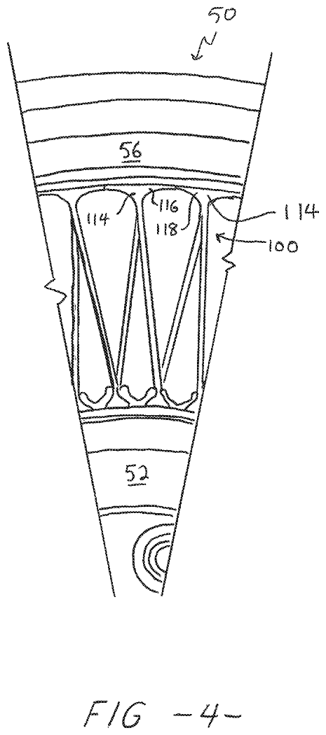

FIG. 3 shows a partial view of an example of a prior art wheel having a spoke where the radially outer portion of each spoke does not extend to the radially outer end of the adjacent spoke element. In contrast, the radially outer anchors 112 of each spoke 100 of the present invention extend to the radially outer anchor 112 of the adjacent spoke 100 as exemplarily shown in FIG. 4.

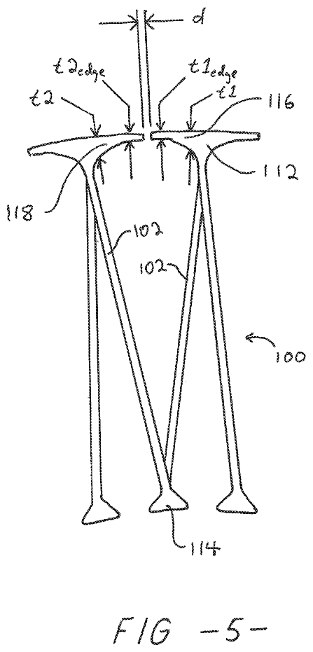

In some embodiments, as shown in FIG. 4, the first radially outer anchor arm 116 may contact the second radially outer anchor arm 118 of the adjacent spoke. Alternatively, as shown in FIG. 5, the adjacent spokes' radially outer anchor arms 116, 118 may extend proximate to one another such that the distance between the edges of the spokes, d, is equal to or less than the lesser of either the thickness, t1_{edge}, of the edge of the first radially outer anchor arm 116 or the thickness, t2_{edge}, of the edge of the second radially outer anchor arm 118. The edges of adjacent radially outer anchor arms 112 may be separated by another material such as adhesive or gum rubber, or by a gap. FIG. 5 is an exemplary embodiment of the spokes 100 of the tire and the spacing of the spokes of this particular embodiment, but does not show the outer compliant band for clarity.

As shown in FIG. 5, the thicknesses t1, t2 of the first radially outer anchor arm 116 and the second radially outer anchor arm 118 are greater at a location adjacent to the web-like body 102 than the thickness t1_{edge}, t2_{edge} at the edge of the spokes. The result in the embodiment shown in FIG. 5 is that the radially outer anchor arms 112 of the spoke 100 taper as they extend circumferentially away from the spoke web-like body 102.

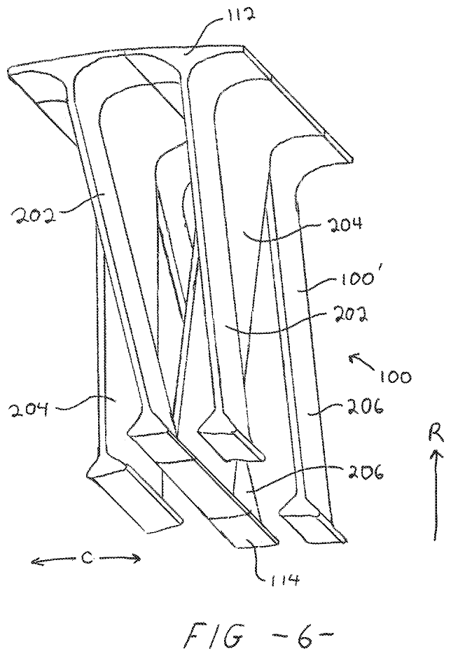

FIG. 6 shows a radially outward oriented perspective view of two adjacent spokes 100 each split into three spoke segments 100′ with the compliant load supporting band 56 not shown. In this exemplary embodiment, the radially inner anchor 114 of the center spoke segment 204 is anchored to the hub at a circumferential location that is axially adjacent to the radially inner anchor 114 of the adjacent spoke's first outer spoke segment 202 and the inner anchor 114 of the same adjacent spoke's second outer spoke segment 206. The radially inner anchors 114 of the spoke segments 202, 204 and 206 are thereby aligned with a single axially oriented slot 66 in the hub 52 as shown in FIG. 1 and FIG. 2. Such alignment simplifies hub construction by allowing a single slot 66 to receive multiple spoke segments 100′ from adjacent spokes 100 when attaching the non-pneumatic tire 51 to the hub 52.

In alternative embodiments each spoke may be even further deradialized and oriented at a greater angle to the radial direction, allowing for a spoke's center spoke segment 204 to cross over the adjacent spoke and sit axially adjacent to the spoke's first and second outer spoke segments 202, 206 of the spoke circumferentially two or more spokes away from the center spoke segment's spoke. As the deradialization of the spokes increase, the wheel's axial torsional stiffness of the wheel increases. Alternatively the radially inner anchors 114 of the first outer spoke segment 202, the center spoke segment 204 and the second outer spoke segment 206 may be positioned at different positions in the circumferential direction such that they are not aligned and such that the axially oriented slots 66 that receive the inner anchors 114 are not aligned across the width of the hub in the circumferential direction.

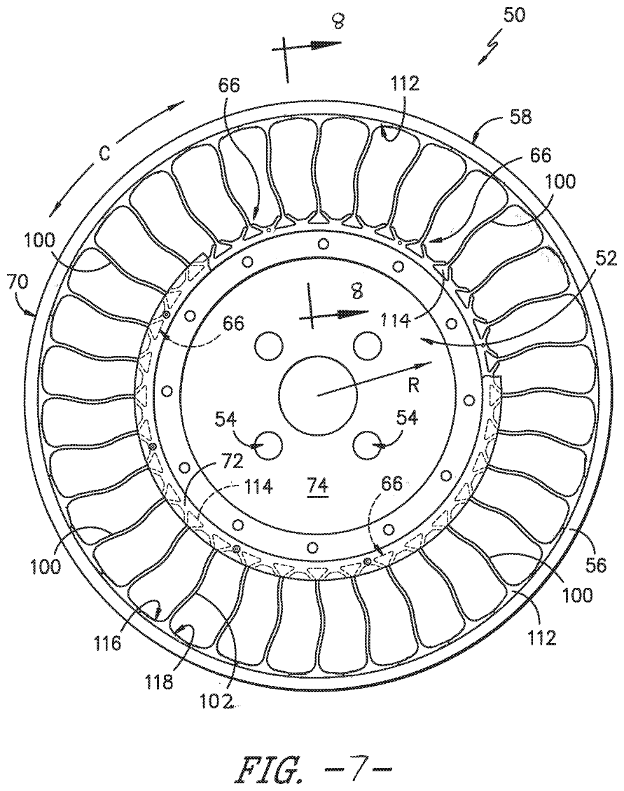

Alternatively, a single spoke segment may form the spoke 100 extending across the lateral width of the wheel 50. Referring now to FIGS. 7, 8 and 9, spoke 100 includes a web-like body 102 extending along the radial direction R. Along radial direction R, web-like body 102 extends between a radially outer end 104 and a radially-inner end 106. Along axial direction A, web-like body 102 extends between opposing edges 108 and 110.

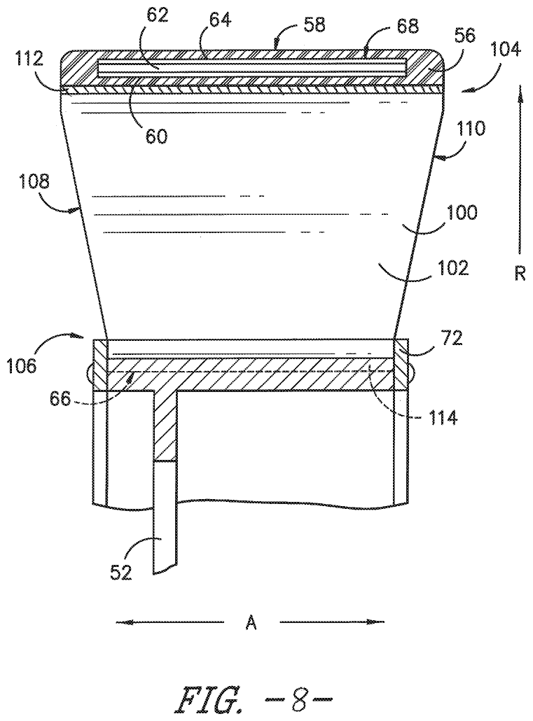

The radially outer end 104 of web-like body 102 forms an outer anchor 112 while the radially-inner end 106 forms inner anchor 114 (FIG. 8). For this exemplary embodiment, the outer anchor 112 includes an outer pair of arms 116 and 118 that extend in an opposing manner or away from each other and body 102 along circumferential direction C. Similarly, inner anchor 114 includes an inner pair of arms 120 and 122 that extend in opposing manner or away from each other and body 102 along circumferential direction C. The present invention is not limited to the particular shape for web spoke 100 shown in the figures and other shapes and configurations may also be used. For example, while web spoke 100 has a familiar “I” shape as shown in FIG. 3 with triangular portions for anchors 112 and 114, other shapes can be used as well. For example, the anchors may have a rectangular cross sectional shape, or alternatively a circular cross sectional shape or alternatively a bulbous shape.

As with previous embodiments, anchors 112 and 114 provide versatility to the use of spoke 100 and its integration into wheel 50. For example, as shown in FIGS. 7 and 8, inner anchor 114 is removably installed within an axially-oriented slot or groove 66 of hub 52. During manufacture, inner anchor 114 can be readily slid along axial direction A or otherwise inserted into groove 66. Such construction also allows hub 52 to be readily substituted in the event of a desired change, repair, or otherwise.

For this exemplary embodiment, outer anchor 112 is attached to load support band 56. A variety of methods may be used to attach band 56 and outer anchor 112. For example, outer anchor 112 may be mechanically fastened or adhered to band 56. Alternatively, outer anchor 112 could be integrally formed with band 56. Other constructions may also be used.

By way of example, load supporting band 56 may be constructed to include shear band 68 having an inner reinforcing band 60, outer reinforcing band 64, and a shear layer 62 positioned therebetween. Shear layer 62 may be constructed e.g. of an elastomeric material such as e.g., natural and synthetic rubbers, polyurethanes, foamed rubbers and polyurethanes, segmented copolyesters, and block co-polymers of nylon. The reinforcing bands 60, 64 may include reinforcements constructed from e.g., essentially inextensible cord reinforcements embedded in an elastomeric coating. Such reinforcements may include e.g., any of several materials suitable for use as wheel belt reinforcements in conventional wheels such as cords of steel, composites of glass and resin such as e.g., fiberglass reinforced polymer, and other materials having a high modulus in tension and compression. Other constructions and materials may be used as well.

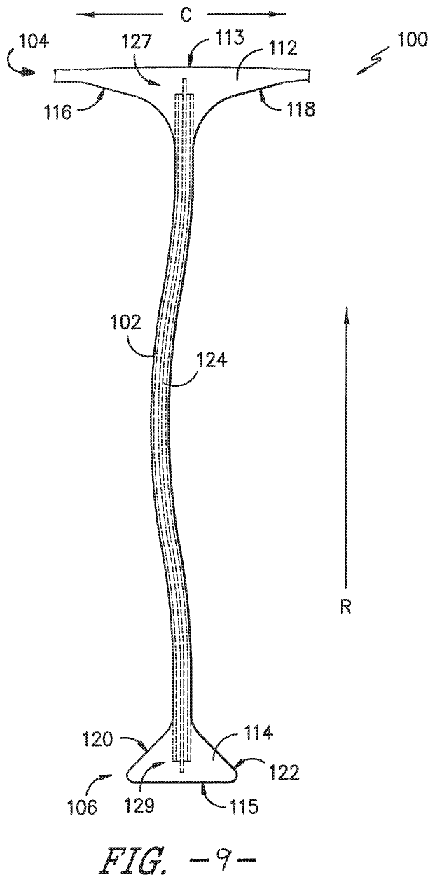

Referring to FIG. 9, web-like body 102 includes a reinforcement structure 124. As shown, reinforcement structure 124 extends along radial direction R between radially-outer end 104 and radially-inner end 106. At radially-outer end 104, reinforcement structure 124 terminates. At radially-inner end 106, reinforcement structure 124 terminates. The reinforcement structure 124 may be folded at the radially-inner end 106 and/or the radially outer end 104 to provide strength to spoke 100 while also helping secure the ends of reinforcement structure 124 in anchors 112 and 114. Such a fold may help reinforcement structure 124 ensure that the tensile forces experienced by web spoke 100 as it rotates away from the contact patch (the area of tread 58 in contact with the ground) and moves to the top of wheel 50 during use are transmitted between hub 52 and compliant band 56.

For this exemplary embodiment, as depicted in FIG. 9, reinforcement structure 124 includes a plurality of elongate, reinforcement elements. In one exemplary embodiment, reinforcement elements are provided as inextensible cords extending adjacent and parallel to each other along radial direction R. More particularly, for this embodiment, reinforcement elements have a length that extends along radial direction R—i.e. reinforcement elements extend longitudinally along radial direction R. Other orientations may be used.

For one exemplary embodiment, as used herein, “inextensible” means the material has an elongation at break of 12 percent or less as measured at 23° C. according to ASTM 885. By way of example, cords may be constructed from nylon, steel, combinations thereof, and other materials as well. Cords may be positioned across the entire axial width W of web-like body 102 so that cords are near edges 108 and 110 or, alternatively, may be positioned across only a portion of width W such that cords are spaced apart from edges 108 and 110. The axial width direction is also referred to as the “lateral width” herein. When referring to a specific component, such as a precursor material used to construct a spoke, indications of direction, such as the radial direction, circumferential direction, lateral direction or axial direction, are used as the precursor material or wheel component is attached to the wheel in its finished position.

Referring to FIG. 9, reinforcement structure 124 can include a plurality of layers of polymeric material to form web-like body 102 as well. For example, in one exemplary embodiment, reinforcement structure 124 includes at least one pair of layers of polymeric material with inextensible cords embedded or sandwiched between layers. Layers extend between the radially-outer end 104 and radially-inner end 106 and, therefore, have substantially the same length and shape as reinforcement structures 124.

For this exemplary embodiment, layers form a first pair of layers immediately adjacent to cords 130 and a second pair of layers are positioned outside of first pair of layers. As with layers, layers extend between the radially-outer end 104 and radially inner end 106 and, therefore, have substantially the same length and shape as reinforcement structures 124.

Various materials can be used for the layers of the reinforcement structure 124. In one exemplary embodiment of the invention, first pair of layers are constructed from a first polymeric material while second pair of layers are constructed from a second polymeric material. For example, the first polymeric material may have e.g., an elongation modulus MA10 (according to ASTM D412) measured at 10 percent elongation and at a temperature of 23° C. that is in the range of 1 to 10 MPa (megapascals). The second polymeric material may have e.g., an elongation modulus MA10 (according to ASTM D412) measured at 10 percent elongation and at a temperature of 23° C. that is in the range of 1 to 5 MPa. The first and second polymeric materials may be constructed of elastomeric materials that are tacky such that e.g., they will self-adhere or stick to themselves and/or each other during manufacture.

Various materials may be used for outer anchor 112 and inner anchor 114. For example, outer anchor 112 may be constructed from a polymeric material having e.g., an elongation modulus MA10 (according to ASTM D412) measured at 10 percent elongation and at a temperature of 23° C. that is in the range of 10 to 30 MPa (megapascals). Inner anchor 114 may be constructed from a polymeric material having e.g., an elongation modulus MA10 (according to ASTM D412) measured at 10 percent elongation and at a temperature of 23° C. that is in the range of 20 to 60 MPa (megapascals).

A variety of shapes may be used for web-like body 102. For example, as shown in FIG. 8, web-like body 102 has a width W that increases along radial direction R moving from the radially-inner end 106 to radially-outer end 104. In other embodiments, width W may decrease, remain constant, or vary. Additionally, the thickness T of web-like body 102 along circumferential direction C may be uniform like the embodiments shown in FIG. 9 or may vary along radial direction R.

An exemplary method of attaching a spoke 100 to a compliant outer band 56, for a non-pneumatic tire 51 will now be set forth. Using the teachings disclosed herein, one of skill in the art will understand that the exemplary method may be used with other exemplary aspects of the invention as well to provide additional exemplary methods. As used herein, the term “method” or “process” refers to one or more steps that may be performed in other ordering than shown without departing from the scope of the presently disclosed invention. Any sequence of steps is exemplary and is not intended to limit methods described herein to any particular sequence, nor is it intended to preclude adding steps, omitting steps, repeating steps, or performing steps simultaneously. As used herein, the term “method” or “process” may include one or more steps performed at least by one electronic or computer-based apparatus having a processor for executing instructions that carry out the steps.

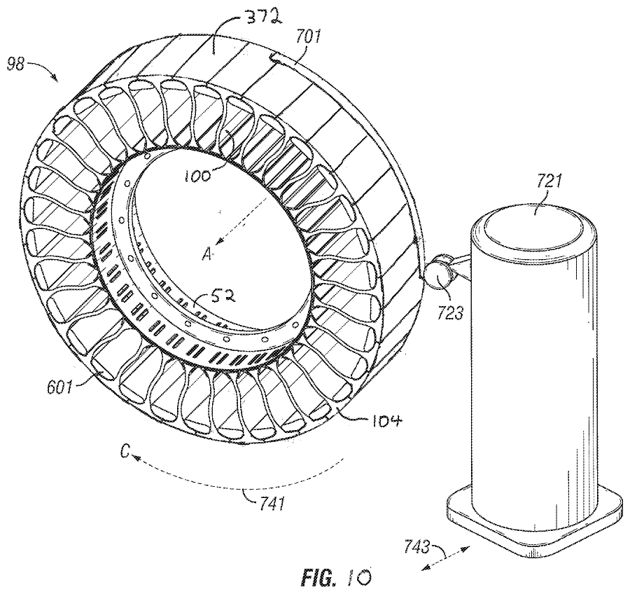

In one exemplary aspect, the present invention provides an exemplary method of manufacturing a non-pneumatic tire for a wheel. FIG. 10 provides a perspective view of the laying of a bonding layer of material 701 upon the radially outer end 104 surface of each spoke 100 of the tire precursor 98. The bonding layer of material 701 may include an uncured rubber strip which can be wound around the outer surface 372 of each spoke, or may include an adhesive for bonding the outer surface 372 to the outer annular band. The material may be dispensed by an extruder 721, then applied by a roller 723 adjacent to the spoke subassembly 98. In this particular embodiment, the extruded material has a width in the axial direction that is less than the width of the finished outer annular band to be bonded to the spokes. As the spoke subassembly 98 rotates about a circumferential direction C, the extruder 721 and roller 723 move in the axial direction applying the bonding layer across the entire outer circumference of the spoke subassembly 98 as shown by the arrows 741, 743 respectively. It should be appreciated that the spoke subassembly 98 may move axially relative to the extruder 721 and likewise the extruder 721 may rotate about the spoke subassembly 98.

In at least one embodiment, outer compliant band can be built upon the outer circumference of the spokes once an adhesive layer or uncured rubber is laid down upon the outer circumference. The radially outer anchors 112 of the spokes 100 are held outward by a plurality of spoke supports 601. In this particular embodiment, the spoke supports 601 resemble finger like protrusions which position and hold the radially outer end 112 of the spokes 100. Here, the extruder 721 delivers strips of rubber and/or tissue that is applied by a roller 723 to the exterior surface of the spoke sub-assembly 98. The spoke subassembly rotates as the extruder 721 moves in an axial direction to apply the strips of rubber and reinforcements to the entire width of the tire.

Once the green rubber and reinforcements are laid upon the outer circumference of the spoke sub-assembly 98 to form a tire precursor, the tire precursor is placed into a mold for curing of the outer annular band including, if present, the reinforcement layers of the outer annular band and tread layer. The mold then applies pressure and heat to cure the outer annular band and form a tread pattern, if desired, into the outer surface of the outer annular band. The inner fingers 601 maintain radially outward pressure during curing.

Upon completion of curing and/or bonding of the spokes to the outer annular band, a non-pneumatic tire is formed. In the embodiment shown, the radially inner portions of the spokes are already attached to a hub. In alternative embodiments, the radially inner portions of the spokes are not attached to a hub during the construction and attachment of the compliant load supporting band 56 and are later attached to a hub 52 once the compliant load supporting band is attached and cured.

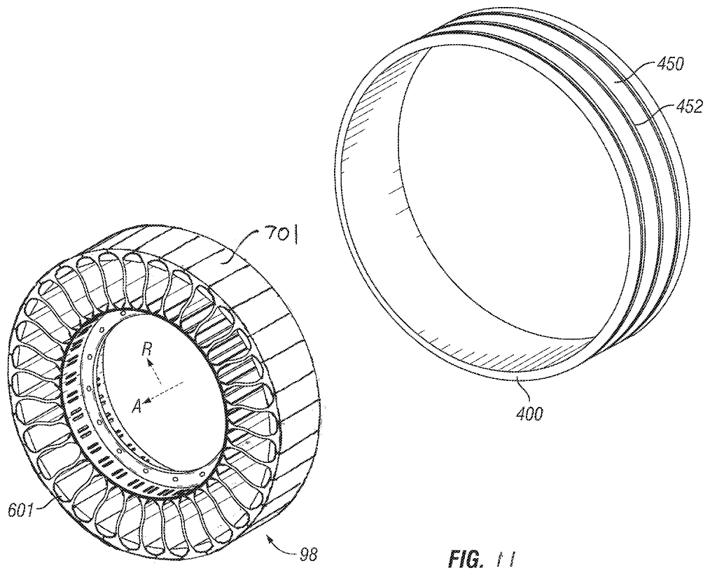

FIG. 11 provides a perspective view of an alternative method of assembling a non-pneumatic wheel using a preformed outer annular band 400 and spoke sub-assembly 98. The outer annular band 400, may be formed separately by traditional tire manufacturing techniques and may comprise of reinforcements including cords such as metal, fiberglass, fiber reinforced plastics, or carbon fiber. Prior to assembly with the spoke subassembly 98, the outer band 400 may be cured and a tread pattern applied to the outer surface. The outer surface of the spokes may have a bonding layer applied, for example, by a method as described above. Alternatively, a bonding layer may be applied to the inner circumferential surface of the outer annular band 400.

The preformed outer annular band 400 is concentrically slipping over the spoke subassembly 98. The spoke subassembly 98 has an outer diameter that is less than the inner diameter of the outer annular band 400, allowing the outer annular band to be placed over the spoke sub-assembly 98. To facilitate outer annular band and spoke sub-assembly positioning, the radial position of the spoke supports 601 may be retracted radially inward to reduce the outer diameter of the spoke sub-assembly 98 while the outer band 400 is positioned around the spoke subassembly 98. Once the outer annular band and spoke sub-assembly are positioned relative to one another, the radial position of the spoke supports 601 may then be expanded radially outward so that the bonding layer 701 makes contact with the inner surface of the outer annular band. Once the preformed outer annular band 400 and the spoke subassembly 98 are assembled, heat and pressure may be applies to cure the bonding layer 701 or, alternatively, expanded for a time sufficient to allow an adhesive to cure.

In any of the above exemplary methods of assembling the spokes 100 to the compliant load supporting band, the radially inner end 106 of each spoke may be attached to a hub 52 to form a non-pneumatic wheel 50, or left unattached to form a non-pneumatic tire 51 which may be then attached to a hub 52 to form a non-pneumatic wheel 50.

In an alternative, exemplary aspect of the present invention, web spoke 100 or embodiments thereof may be manufactured from e.g., polyurethane or silicone elastomers. Various molding processes may be used to manufacture web spoke 100 from such materials including e.g., injection molding, compression molding, or casting.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

1. An improved non-pneumatic tire for attachment to a hub defining radial, axial, and circumferential directions, the tire comprising:
a compliant tread-band;
a plurality of rubber spokes extending radially inward from compliant tread-band for attachment to the hub, each of the plurality of spokes further comprising:
a web-like body extending along the radial direction between a radially-outer end and a radially-inner end and extending in an axial direction between opposing edges of the web-like body, the web-like body further comprising a plurality of elongate reinforcement elements oriented in the radial direction; and
an outer anchor positioned at the radially outer end comprising a first arm and a second arm, each extending in an opposing manner along the circumferential direction away from the web-like body, the first arm extending in a first circumferential direction and the second arm extending in a second circumferential direction, the outer anchor attached to the compliant tread band;
wherein the first arm of the outer anchor of each spoke extends proximate to the second arm of the outer anchor of the adjacent spoke.

2. The non-pneumatic tire as in claim 1 wherein the first arm further comprises:
an edge distal from the web-like body in the circumferential direction;
a thickness in the radial direction, the first arm thickness greater at a location adjacent to the web-like body than the first arm thickness is at the edge of the first arm;
wherein the second arm further comprises:
an edge distal from the web-like body in the circumferential direction; and
a thickness in the radial direction, the second arm thickness greater at a location adjacent to the web-like body than the second arm thickness is at the edge of the second arm;
the first arm of the outer anchor of each spoke extends proximate to the second arm of the outer anchor of the adjacent spoke such that the distance between the first arm and the second arm of the adjacent spoke is less than the lesser of the thickness at the edge of the first arm or the thickness at the edge of the second arm.

3. The non-pneumatic tire as in claim 1 wherein the first arm of the outer anchor of each spoke touches the second arm of the outer anchor of the adjacent spoke.

4. The non-pneumatic tire as in claim 1, wherein the first arm of the outer anchor of each spoke is bonded to the second arm of the outer anchor of the adjacent spoke.

5. The non-pneumatic tire as claim 4 wherein the first arm of the outer anchor of each spoke is bonded with vulcanized rubber to the second arm of the outer anchor of the adjacent spoke.

6. The non-pneumatic tire as in claim 1, wherein the plurality of elongate reinforcement elements comprises a plurality of inextensible cords.

7. The non-pneumatic tire as in claim 1, wherein the reinforcement structure comprises:
a plurality of inextensible cords extending between the radially-outer end and the radially-inner end; and
at least one pair of layers comprising a polymeric material, wherein the layers extend between the radially-outer end and the radially inner end with the inextensible cords embedded between the layers.

8. The non-pneumatic tire as in claim 7, wherein the inextensible cords comprise steel.

9. The non-pneumatic tire as in claim 7, wherein the inextensible cords comprise fiber reinforced polymer.

10. The non-pneumatic tire as in any one of claim 1, wherein the reinforcement structure comprises:
a plurality of inextensible cords extending between the radially-outer end and the radially-inner end; and
a first pair of layers comprising a first polymeric material, wherein the first pair of layers extend between the radially-outer end and the radially-inner end with the inextensible cords embedded between the first pair layers; and
a second pair of layers comprising a second polymeric material, wherein the second pair of layers extend between the radially-outer end and the radially-inner end.

11. The non-pneumatic tire as in claim 10, wherein the first polymeric material has an elongation modulus MA10 measured at 10 percent elongation and at a temperature of 23° C. that is in the range of 1 to 10 MPa.

12. The non-pneumatic tire as in claim 11, wherein the second polymeric material has an elongation modulus MA10 measured at 10 percent elongation and at a temperature of 23° C. that is in the range of 1 to 5 MPa.

13. The non-pneumatic tire as in claim 1, further comprising an inner anchor positioned at the radially inner end comprising an inner pair of arms extending in an opposing manner along the circumferential direction away from the web-like body.

14. The non-pneumatic tire as in claim 1, wherein along the axial direction between the opposing edges the web-like body has a width that increases along the radial direction from the radially-inner end to the radially-outer end.

15. The non-pneumatic tire as in claim 1, wherein the outer anchor comprises a polymeric material having an elongation modulus MA10 measured at 10 percent elongation and at a temperature of 23° C. that is in the range of 10 to 30 MPa.

16. The non-pneumatic tire as in claim 11, wherein the inner anchor comprises a polymeric material having an elongation modulus MA10 measured at 10 percent elongation and at a temperature of 23° C. that is in the range of 20 to 60 MPa.

17. The non-pneumatic tire as in claim 1, wherein the spoke is comprised of multiple segments that together span axially across the tire.

18. The non-pneumatic tire as in claim 1, wherein the radially-inner end of each of the plurality of spokes is attached to the hub to form a wheel.

19. An improved non-pneumatic tire for attachment to a hub defining radial, axial, and circumferential directions, the tire comprising:
a compliant tread-band;
a plurality of rubber spokes extending radially inward from compliant tread-band for attachment to the hub, each of the plurality of spokes further comprising:
a web-like body extending along the radial direction between a radially-outer end and a radially-inner end and extending in an axial direction between opposing edges of the web-like body, the web-like body further comprising a plurality of elongate reinforcement elements oriented in the radial direction; and
an outer anchor positioned at the radially outer end comprising a first arm and a second arm, each extending in an opposing manner along the circumferential direction away from the web-like body, the first arm extending in a first circumferential direction and the second arm extending in a second circumferential direction, the outer anchor attached to the compliant tread band;
wherein the first arm of the outer anchor of each spoke extends proximate to the second arm of the outer anchor of the adjacent spoke
wherein the first arm further comprises:
an edge distal from the web-like body in the circumferential direction;
a thickness in the radial direction, the first arm thickness greater at a location adjacent to the web-like body than the first arm thickness is at the edge of the first arm;
wherein the second arm further comprises:
an edge distal from the web-like body in the circumferential direction; and
a thickness in the radial direction, the second arm thickness greater at a location adjacent to the web-like body than the second arm thickness is at the edge of the second arm;
the first arm of the outer anchor of each spoke extends proximate to the second arm of the outer anchor of the adjacent spoke such that the distance between the first arm and the second arm of the adjacent spoke is less than the lesser of the thickness at the edge of the first arm or the thickness at the edge of the second arm.

20. The non-pneumatic tire as in claim 19 wherein the first arm of the outer anchor of each spoke is bonded to the second arm of the outer anchor of the adjacent spoke.
